(19) United States
(12) Patent Application Publication
(10) Pub. No.: US 2014/0101553 A1
(43) Pub. Date: Apr. 10, 2014

(54) MEDIA INSERTION INTERFACE

(71) Applicant: Jens Nagel, Sunnyvale, CA (US)

(72) Inventor: Jens Nagel, Sunnyvale, CA (US)

(21) Appl. No.: 13/648,942

(22) Filed: Oct. 10, 2012

(51) Int. Cl. G06F 3/048; G06F 3/16

(52) U.S. Cl. 715/728; 715/773; 715/753

(57) ABSTRACT

A computing device may output a graphical user interface for display at a presence-sensitive screen including an edit region and a graphical keyboard. The computing device may receive an indication of a gesture detected at a location of the presence-sensitive screen within the graphical keyboard. In response, the computing device may output for display at the presence-sensitive screen, a modified graphical user interface including a media insertion user interface with a plurality of media insertion options. The computing device may receive an indication of a selection of at least one media insertion option associated with a media item. The computing device may output for display at the presence-sensitive screen, an updated graphical user interface including the media item within the edit region.

### BACKGROUND

Some computing devices (e.g., mobile phones, tablet computers, etc.) provide a graphical keyboard as part of a graphical user interface (“GUI”) for entering text using a presence-sensitive screen. While such graphical keyboards may provide a convenient means for entry of text into a document (e.g., an e-mail, a text message, a word-processing document, etc.), a graphical keyboard may not provide a convenient mechanism for composition of a multimedia document that includes both text and media (e.g., an image, video clip, etc.).

### SUMMARY

In one example, a method may include outputting, by a computing device and for display at a presence-sensitive screen, a graphical user interface. The graphical user interface may include an edit region and a graphical keyboard. The method may further include receiving, by the computing device, a gesture at a location of the presence-sensitive screen within the graphical keyboard. Responsive to receiving the indication of the gesture, the method may also include outputting, by the computing device and for display at the presence-sensitive screen, a modified graphical user interface including a media insertion user interface. The media insertion user interface may include a plurality of media insertion options. In addition, the method may include receiving, by the computing device, an indication of a selection of at least one of the plurality of media insertion options. The at least one selected media insertion option may be associated with a media item. In response to receiving the indication of the selection, the method may further include outputting, by the computing device and for display at the presence-sensitive screen, an updated graphical user interface including the media item within the edit region.

In another example, a computing device comprising one or more processors being configured to output for display at a presence-sensitive screen, a graphical user interface including an edit region, a graphical keyboard, and a media key. The one or more processors also being configured to receive an indication of a gesture detected at a location of the presence-sensitive screen within the media key. In response to receiving the indication of the gesture, the one or more processors also being configured to output for display at the presence-sensitive screen a modified graphical user interface including a media insertion user interface in place of the graphical keyboard. The media insertion user interface may include a plurality of media insertion options. The one or more processors also being configured to receive an indication of a selection of at least one of the plurality of media insertion options. The at least one selected media insertion option may be associated with a media item. In response to receiving the indication of the selection, the one or more processors also being configured to output for display at the presence-sensitive screen, an updated graphical user interface including the media item within the edit region and removing the media insertion user interface. The one or more processors also being configured to output a message that includes the media item.

In another example, the disclosure is directed to a computer-readable storage medium comprising instructions that, when executed configure one or more processors of a computing device to output for display at a presence-sensitive screen, a graphical user interface including an edit region, a graphical keyboard, and a media key. The instructions, when executed, further configure one or more processors of a computing device to receive an indication of a gesture detected at a location of the presence-sensitive screen within the media key. In response to receiving the indication of the gesture, the instructions, when executed, further configure one or more processors of a computing device to output for display at the presence-sensitive screen, a modified graphical user interface including a media insertion user interface. The media insertion user interface may include a plurality of media insertion options. The instructions, when executed, further configure one or more processors of a computing device to receive an indication of a selection of at least one of the plurality of media insertion options. The at least one selected media insertion option may be associated with a media item. In response to receiving the indication of the selection, the instructions, when executed, further configure one or more processors of a computing device to output for display at the presence-sensitive screen an updated graphical user interface including the media item within the edit region.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1C are conceptual diagrams illustrating example graphical user interfaces for inserting media objects, in accordance with one or more aspects of the present disclosure.

FIG. 2 is a block diagram illustrating an example computing device, in accordance with one or more aspects of the present disclosure.

FIGS. 3A-3D are conceptual diagrams illustrating additional example graphical user interfaces for inserting media objects, in accordance with one or more aspects of the present disclosure.

FIG. 4 is a flowchart illustrating an example operation of the computing device, in accordance with one or more aspects of the present disclosure.

### DETAILED DESCRIPTION

A graphical keyboard of a mobile computing device may not provide a convenient mechanism for the user to compose a multimedia document that includes both text and a media item (e.g., an image, a video clip, etc.). For example, to enter an image into a text message, a GUI of a messaging application may require the user to temporarily navigate outside the messaging application to an image management or gallery application. Within the image management or gallery application, the user may browse through one or more images, then select and provide input instructing the mobile computing device to copy the image to a shared memory on the mobile computing device (e.g., a “clipboard”). Next, the user may navigate back to the messaging application and provide input instructing the mobile computing device to paste the image from the clipboard into the message. As such, a user may require more time to compose a multimedia message than a regular “text only” message.

Techniques of this disclosure facilitate the insertion of media items into a text-based message, document, or field, without requiring the mobile computing device to switch applications—thereby providing a more fluid user experience. A computing device (e.g. mobile phone, tablet computer, etc.) may output for display at a presence-sensitive screen, a GUI for composing an electronic document or message (e.g. as part of a word-processing document, an electronic mail message, a text message, etc.). The user interface may include a graphical keyboard for inputting text on the presence-sensitive screen. In one example, in addition to standard keyboard keys (typically used for inputting text), the graphical keyboard may also include a media key for quickly selecting and inserting a media item into the body of a document or a message within an edit region of the GUI presented on the presence-sensitive screen. In another example, responsive to receiving an indication of a gesture detected at a location of the presence-sensitive screen within the graphical keyboard, the computing device may output a user interface on the presence-sensitive screen including a media insertion menu for quickly selecting and inserting a media item (e.g., an image, a video clip, a map, navigation directions, an address book entry, etc.) into the body of a document or a message.

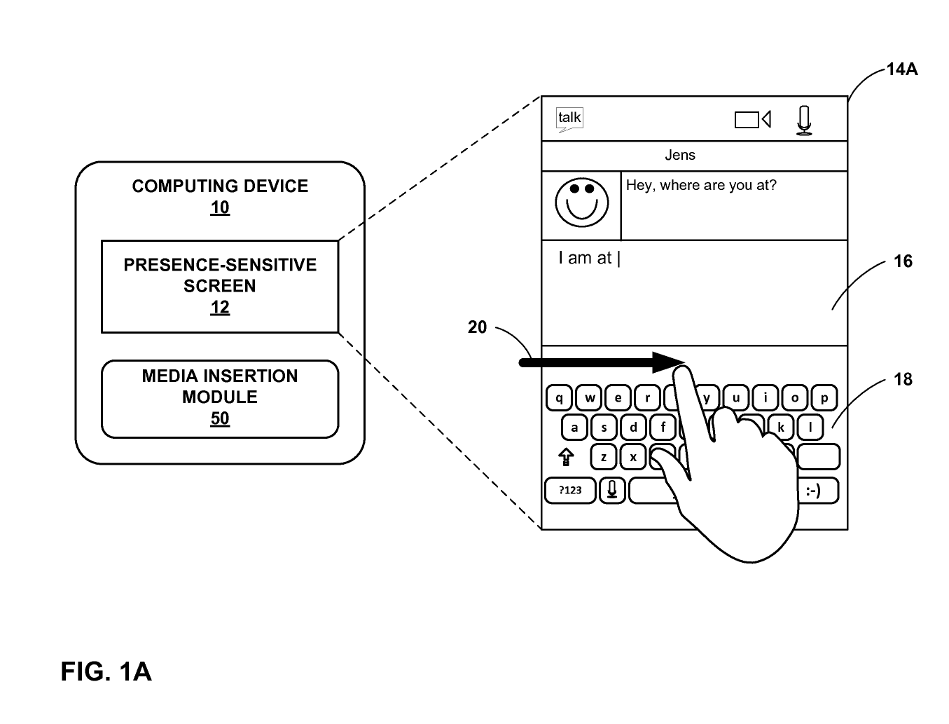

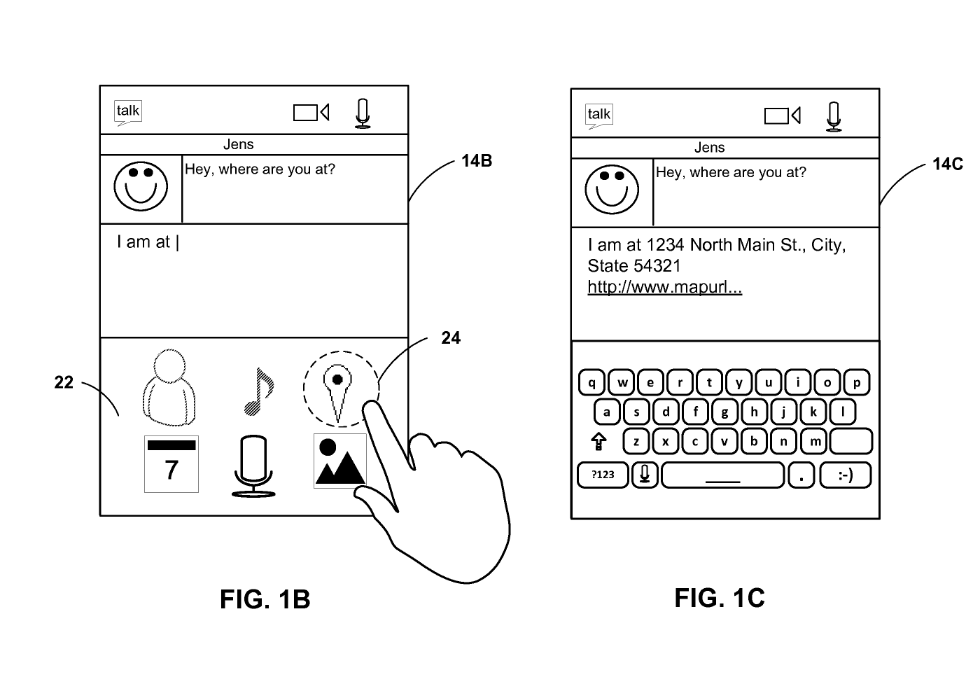

FIGS. 1A-1C are conceptual diagrams illustrating example GUIs for inserting media objects, in accordance with one or more aspects of the present disclosure. In the example of FIG. 1A, computing device 10 is a mobile phone. However, in other examples, computing device 10 may be a cellular phone, a personal digital assistant (PDA), a laptop computer, a tablet computer, a portable gaming device, a portable media player, an e-book reader, a watch, or another type of portable or mobile computing device. Furthermore, in other examples, computing device 10 may be a non-portable computing device such as desktop computer, a landline telephone, or a television.

In the example of FIGS. 1A-C, computing device 10 includes a presence-sensitive screen 12 (“screen 12”). Screen 12 of computing device 10 may include a touchscreen configured to receive tactile user input from a user or other users of computing device 10. Screen 12 may receive tactile user input as one or more taps and gestures. For example, screen 12 may detect taps or gestures in response to the user touching or pointing to a location of screen 12 with a finger or stylus pen. Screen 12 may be implemented using various technologies. For example, screen 12 may be implemented using a resistive touchscreen, a surface acoustic wave touchscreen, a capacitive touchscreen, a projective capacitance touchscreen, a pressure sensitive screen, an acoustic pulse recognition touchscreen, or another touchscreen technology.

Screen 12 may include any one or more of a liquid crystal display (LCD), dot matrix display, light emitting diode (LED) display, organic light-emitting diode (OLED) display, e-ink, or similar monochrome or color display capable of outputting visible information to the user of computing device 10 and for receiving tactile input from the user. Screen 12 presents a user interface (e.g., user interface 14A), which may be related to functionality provided by computing device 10. For example, screen 12 may present various functions and applications including, e.g. an e-mail client, a text messaging client, a voicemail client, a map application, an address book, an image library, a song library, a calendar, and a web browser for accessing and downloading information from the Internet. In another example, screen 12 may present a menu of options related to the function and operation of computing device 10, such as screen brightness and other configurable mobile phone settings.

Computing device 10 may output user interfaces 14A, 14B, and 14C (collectively, “user interfaces 14”) for display at screen 12. Each of user interfaces 14 include graphical elements displayed at various locations of screen 12. For example, FIG. 1A illustrates an edit region 16 and a graphical keyboard 18 included as part of user interface 14A (e.g., as part of a messaging application executing on computing device 10 for composing text messages). Graphical keyboard 18 includes graphical elements displayed as keys on a keyboard. Edit region 16 includes graphical elements displayed, in some cases, as characters of text.

Computing device 10 may include a media insertion module 50 for interpreting selections made by the user of graphical elements in user interfaces 14. For example, the user may wish to insert text into edit region 16 of user interface 14A. Computing device 10 may receive user input detected at a particular location at screen 12. Media insertion module 50 may interpret from the indication of the user input, a selection of one or more keys displayed on graphical keyboard 18. Media insertion module 50 may further determine the selection of keys represents a string of characters, with each character from the string, associated with a selected key.

Media insertion module 50 may command computing device 10 to output for display at screen 12, the string of characters interpreted from the key selection. Computing device 10 may output the string of characters as graphical elements within edit region 16 of user interface 14A. The graphical elements (e.g. string of characters) displayed within edit region 16 may form the body of an electronic document or message composed by the user.

The user may wish to insert more than just text into an electronic document or message. For example, the user may wish to insert media items such as images, video clips, songs, hyperlinks, voicemails, voice memos, address book entries, calendar events, geographic locations, maps, and directions. In accordance with techniques of the disclosure, computing device 10 may provide a shortcut to insert a media item into edit region 16 of user interfaces 14 through a media insertion user interface (e.g., media insertion user interface 22). That is, the media insertion user interface 22 may alleviate the need for the user to physically type on graphical keyboard 18, navigate to another application or to perform cut, copy, or paste functions to insert a media item into an electronic document or message. Computing device 10 may activate media insertion user interface 22 based on a gesture input from the user.

Computing device 10 may receive an indication of a gesture at screen 12 (e.g., gesture 20) detected at a location of screen 12 within graphical keyboard 18. In the examples of FIGS. 1A-1C, a user would like to insert information associated with a current geographic location of computing device 10 into a text message using media insertion user interface 22. As illustrated in FIG. 1A, the user may swipe a finger across graphical keyboard 18 to command computing device 10 to display media insertion user interface 22. Media insertion module 50 may receive an indication of gesture 20 from screen 12 detected at a location of screen 12 within graphical keyboard 18.

As shown in FIG. 1B, responsive to receiving the indication of gesture 20, computing device 10 may output a modified user interface 14B including media insertion user interface 22. Media insertion user interface 22 may include a plurality of media insertion options (e.g., options for inserting a media item into edit region 16). For example, media insertion module 50 may activate media insertion user interface 22 based on gesture 20. Media insertion module 50 may command screen 12 to output modified user interface 14B including media insertion user interface 22 at screen 12. Computing device 10 may output media insertion user interface 22 either entirely or partially in place of edit region 16 and graphical keyboard 18. FIG. 1B illustrates that computing device 10 may output modified user interface 14B that includes media insertion user interface 22 in place of graphical keyboard 18.

Computing device 10 may receive an indication of a selection 24 of at least one of the plurality of media insertion options. The selected media insertion option may correspond to a media item. Continuing the example shown in FIG. 1B, after screen 12 displays media insertion user interface 22, the user may tap a finger over a map location symbol displayed in media insertion user interface 22 (e.g., selection 24). Media insertion module 50 may receive an indication of selection 24 from screen 12. Media insertion module 50 may determine that selection 24 corresponds to a selection of a graphic element in media insertion user interface 22 (e.g., a “location” symbol). For example, media insertion module 50 may determine that selection 24 indicates a selection, made by the user, of a geographic location media item option that corresponds to inserting a geographic location media item into edit region 16.

Responsive to receiving the indication of selection 24, computing device 10 may output an updated user interface 14C to screen 12, including the media item within edit region 16. For example, responsive to receiving the indication of selection 24, media insertion module 50 may determine a modification to user interface 14B which includes inserting the geographic location media item into edit region 16. In this example, the geographic location media item includes text that corresponds to an address of a location associated with computing device 10 (e.g., “1234 North Main St., City, State”) and a hyperlink to an Internet website displaying a map of the device location (e.g., “http://www.mapurl . . . ”). Media insertion module 50 may command screen 12 to display user interface 14C, which includes the geographic location media item. In this manner, media insertion user interface 22 may alleviate the need for the user to physically type the address associated with the current location of computing device 10.

Media insertion user interface 22 shows only some example shortcuts for inserting media items (e.g., images, video clips, hyperlinks, maps, navigation directions, etc.) into edit region 16, many other shortcuts for any number of different media items exist. In one example, media insertion user interface 22 does not include a shortcut of inserting an emoticon (e.g., a smiley face, a sad face, etc. used in a text based message to indicate emotion of an author of the text based message). As one example, prior to inputting a media item in edit region 16, computing device 10 may modify media insertion user interface 22 in response to selection 24. The modified media insertion user interface 22 may include a map user interface that includes additional options, selectable by the user, to format the media item prior to inserting the media item in edit region 16. The additional format options may include displaying text of an address, a hyperlink to a map downloadable from the Internet, an image of a map, and both navigational directions and a physical distance between computing device 10 and a location.

Media insertion user interface 22 may provide a shortcut for the user to input media items in edit region 16. The shortcut may minimize time spent by the user to insert a media item into edit region 16. By creating a simpler method to input media items, the user may perform a particular task, such as composing a multimedia text message, in fewer operations with computing device 10. With the user performing fewer operations, computing device 10 may operate more efficiently and may consume less processing resources. Performing fewer operations to perform a single task may likewise reduce power consumed by computing device 10.

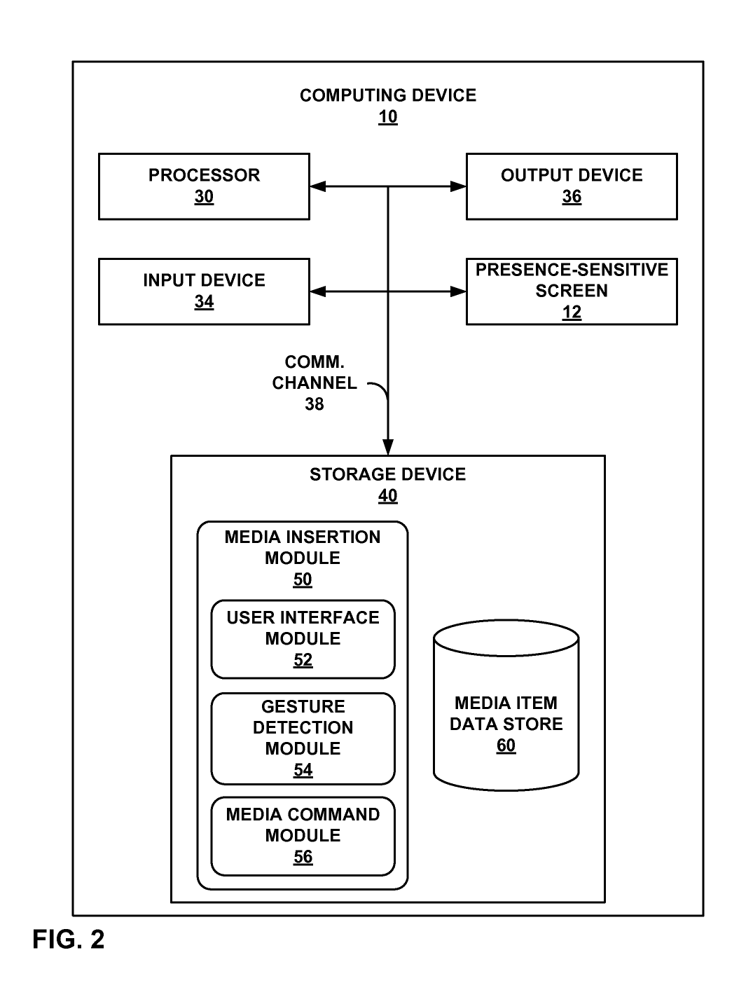

FIG. 2 is a block diagram illustrating an example configuration of the computing device. For purposes of illustration, FIG. 2 is described below within the context of FIGS. 1A-1C, in conjunction with computing device 10 of FIG. 2. FIG. 2 illustrates only one particular example of computing device 10, and many other example configurations of computing device 10 exist. As shown in the example of FIG. 2, computing device 10 includes presence-sensitive screen 12 (“screen 12”), one or more processors 30, one or more input devices 34, one or more output devices 36, and one or more storage devices 40. In this example, storage devices 40 of computing device 10 also include media insertion module 50 and one or more media item data stores 60. Media insertion module 50 includes user interface module 52, gesture detection module 54, and media command module 56. Communication channels 38 may interconnect each of the components 12, 30, 34, 36, 40, 50, 52, 54, 56, and 60 for inter-component communications (physically, communicatively, and/or operatively). In some examples, communication channels 38 may include a system bus, a network connection, an inter-process communication data structure, or any other method for communicating data.

One or more processors 30 may implement functionality and/or execute instructions within computing device 10. For example, processors 30 may process instructions stored in storage devices 40 that execute the functionality of gesture detection module 54.

One or more storage devices 40 within computing device 10 may store information required for use during operation of computing device 10 (e.g., computing device 10 may store information associated with one or more media items in one or more media item data stores 60). Storage devices 40, in some examples, have the primary purpose of being a short term and not a long-term computer-readable storage medium. Storage devices 40 on computing device 10 may be volatile memory and therefore not retain stored contents if powered off. Examples of volatile memories include random access memories (RAM), dynamic random access memories (DRAM), static random access memories (SRAM), and other forms of volatile memories known in the art. Storage devices 40 may further be configured for long-term storage of information as non-volatile memory space and retain information after power on/off cycles. Examples of non-volatile memory configurations include magnetic hard discs, optical discs, floppy discs, flash memories, or forms of electrically programmable memories (EPROM) or electrically erasable and programmable (EEPROM) memories. In some examples, processors 30 on computing device 10 read and execute instructions stored by storage devices 40. In addition, media insertion module 50, user interface module 52, gesture detection module 54, and media command module 56 may store information within storage devices 40 during program execution.

Computing device 10 may include one or more input devices 34 that computing device 10 uses to receive input. Examples of input are tactile, audio, and video input. Input devices 34 of computing device 10, in one example, includes a presence-sensitive screen, touch-sensitive screen, mouse, keyboard, voice responsive system, video camera, microphone or any other type of device for detecting input from a human or machine.

Computing device 10 may include one or more output devices 36 that computing device 10 uses to generate output. Examples of output are tactile, audio, and video output. Output devices 36 of computing device 10, in one example, includes a presence-sensitive screen, sound card, video graphics adapter card, speaker, cathode ray tube (CRT) monitor, liquid crystal display (LCD), or any other type of device for generating output to a human or machine.

Computing device 10 may include presence-sensitive screen 12 (“screen 12”). Computing device 10 may use screen 12 as an input device and an output device. For example screen 12 of computing device 10 may include a touchscreen configured to receive tactile input from a user and may also include a color display configured to present graphics, images, and videos to the user.

Storage devices 40 may store program instructions and/or data associated with media insertion module 50, user interface module 52, gesture detection module 54, media command module 56, and media item data stores 60. For example, media command module 56 may include instructions that cause processors 30 of computing device 10 to perform one or more of the operations and actions described in the present disclosure. The operations and actions may require computing device 10 to read and/or write data to media item data stores 60.

In accordance with the techniques of this disclosure, a computing device may output, for display at a presence-sensitive screen operatively coupled to the computing device, a GUI that includes an edit region and a graphical keyboard. For example, processors 30 of computing device 10 may execute instructions associated with user interface module 52 that cause, processors 30 to transmit one or more display commands to screen 12 of output devices 36. The one or more display commands may cause screen 12 to output for display a GUI, such as user interface 14A of FIG. 1A. In addition, the one or more display commands may further cause screen 12 to output an edit region 16 and a graphical keyboard 18 as part of user interface 14A.

User interface module 52 may control the information displayed at screen 12 and process input received from screen 12. User interface module 52 may output display commands to screen 12 that cause screen 12 to display graphical elements within user interfaces 14. User interface module 52 may receive indications of inputs detected by screen 12 at locations of screen 12 and interpret the inputs as selections of graphical elements within user interfaces 14. For example, user interface module 52 may send a display command to screen 12 to display graphical keyboard 18 at a location or within a region of screen 12. The display command from user interface module 52 may include instructions for including graphical elements that screen 12 presents as soft keys on a keyboard. Screen 12 may receive an indication of an input detected at the location at screen 12 that displays graphical keyboard 18 (e.g. the user may tap a finger on the soft key graphical elements displayed at screen 12). User interface module 52 of computing device 10 may receive the input from screen 12 over communication channels 38 and interpret the input as a selection of keys and determine the key selection corresponds to a string of characters. User interface module 52 of computing device 10 may transmit a display command over communication channels 38 to screen 12. The display command may include instructions for displaying the string of characters in edit region 16. Responsive to receiving the display command from user interface module 52, screen 12 may output for display each character from the string within edit region 16 of user interface 14A. The user may view the characters displayed in edit region 16 to confirm the accuracy of input received at screen 12.

Computing device 10 may receive an indication of a gesture detected at a location of the presence-sensitive screen within graphical keyboard 18. For example, as illustrated in FIG. 1A, the user may swipe a finger across graphical keyboard 18 to command computing device 10 to display media insertion user interface 22. Screen 12 may detect the finger swipe as multiple inputs and transmit the inputs over communication channels 38. Gesture detection module 54 of computing device 10 may receive the inputs from screen 12 and interpret the inputs as an indication of gesture 20. Gesture detection module 54 may determine gesture 20 corresponds to a user command to display media insertion user interface 22 of FIG. 1B.

Responsive to receiving the indication of gesture 20, computing device 10 may output a modified GUI 14B including a media insertion user interface. The media insertion user interface may include a plurality of media insertion options. For example, after gesture detection module 54 determines gesture 20 corresponds to a user command to display media insertion user interface 22, gesture detection module 54 may transmit a gesture command over communication channels 38 to user interface module 52. The gesture command may include instructions to modify user interface 14A to include media insertion user interface 22. Upon receiving the gesture command, user interface module 52 may determine a modification to user interface 14A that includes displaying a media insertion user interface 22. The modification to user interface 14A may further include displaying a plurality of media insertion options as graphical elements within media insertion user interface 22. User interface module 52 may transmit a display command to screen 12 with instructions for modifying user interface 14A. Screen 12, in response to the display command, may output modified user interface 14B (as illustrated in FIG. 1B).

The computing device may receive an indication of a selection of at least one of the plurality of media insertion options. The at least one selected media insertion option may correspond to a media item. For example, after screen 12 outputs user interface 14B which includes media insertion user interface 22, the user may use a finger or stylus to tap screen 12 at the region of screen 12 associated with one of the graphical elements that correspond to one of the media insertion options. Screen 12 may receive the finger tap as a touch input and transmit the touch input over communication channels 38. User interface module 52 of computing device 10 may receive the touch input from screen 12 and process the touch input as an indication of a selection 24 of one of the plurality of media insertion options included in media insertion user interface 22. User interface module 52 may transmit a selection command over communication channels 38 to media command module 56. The selection command may include data for determining the media insertion option selected by the user. Media command module 56 may receive the selection command, and based on data included within the selection command, determine the media insertion option selected by the user.

Media command module 56 may associate a media item stored in media item data stores 60 with the media insertion option. For example, based on the selection command received from user interface module 52, media command module 56 may determine the user selected a geographic location media insertion option. Media command module 56 may associate a geographic location media item stored in media item data stores 60 with the geographic location media insertion option. The geographic location media item may include a text string of an address and a hyperlink to a map of the address downloadable from the Internet.

Responsive to receiving the indication of the selection, computing device 10 may output an updated the GUI 14C including the media item within edit region 16. For example, responsive to media command module 56 determining the media insertion option selected by the user, media command module 56 may transmit a media command and either the media item or a pointer to the media item (e.g., data that indicates a location of the media item within media item data stores 60) over communication channels 38. User interface module 52 may receive the media command and either the media item or the media item pointer from media command module 56. In the case of user interface module 52 receiving a media item pointer with the media command, user interface module 52 may use the pointer to the media item to retrieve the media item from the media item data stores 60. User interface module 52 may determine a modification to user interface 14B that includes displaying the media item in edit region 16. For example, in the case where the media item is a geographic location media item, the modification may include inputting a text string of the address associated with the geographic location media item and a hyperlink to a map of the address associated with the geographic location media item in edit region 16.

Responsive to receiving the indication of the selection, the computing device may output GUI 14C removing the media insertion user interface. For example, continuing the description above, user interface module 52 may modify user interface 14B to cause screen 12 to present the media item in edit region 16 and remove, hide, or otherwise stop displaying the media insertion user interface 22 (as shown in user interface 14C of FIG. 1). That is, user interface module 52 may cause screen 12 to output user interface 14C, which includes the geographic location media item in edit region 16, but does not include media insertion interface 22 (as shown in FIG. 1C). Alternatively, computing device 10 may modify user interface 14B to include the media item in edit region 16 and continue to display media insertion user interface 22. In this way, the user may command computing device 10 to perform successive media item insertions without requiring the user to input successive gestures for displaying media insertion user interface 22 at screen 12.

Computing device 10 may output a message that includes the media item. For example, computing device 10 may execute a messaging application on processors 30 for receiving, composing, and transmitting electronic messages (e.g., e-mail, simple message service messages, instant messages, etc.) to another computing device. Computing device 10 may output user interfaces 14 of FIG. 1A-1C at screen 12 as part of the messaging application. After computing device 10 modifies user interface 14B to include the media item within edit region 16 as described above, computing device 10 may output a message that includes the media item within edit region 16 so a user of a computing device that receives the message can view the media item. For example, after screen 12 displays the address and the hyperlink associated with the geographic location media item in edit region 16 of FIG. 1, computing device 10 may output a message that includes data representing the text string “I am at 1234 North Main St., City, State 56321 http://mapurl . . . ”. A computing device different from computing device 10 may receive and display the message. A user of the computing device that receives the message may view the text string “I am at 1234 North Main St., City, State 56321 http://mapurl . . . ”

The media insertion user interface may include an address book user interface, and the media item may include information stored within an entry of an address book. For example, computing device 10 may include an address book application used for storing and retrieving contact information for display at screen 12 of computing device 10 or for use by other applications executing on computing device 10. The address book application may include an address book user interface for display at screen 12. The address book application may contain one or more entries organized, for example, alphabetically using a name associated with each entry. Each entry within the address book may include one or more fields. Each field may provide a location for storing information such as a phone number, an e-mail address, and a mailing address associated with each entry. The address book application may store each address book entry as an address book media item in media item data stores 60.

Responsive to detecting gesture 20, computing device 10 may modify user interface 14A to include a media insertion user interface. However, rather than display user interface 14B, computing device 10 may modify user interface 14A to include, as the media insertion user interface, a subset of the address book application user interface. The address book media insertion user interface may include a plurality of address book media insertion options. Each address book media insertion option may correspond to an address book media item (e.g. an address book entry or a field within an address book entry) that computing device 10 may insert into edit region 16. For example, the user may select a graphical element included within the user interface associated with an address book entry from the address book media insertion user interface (computing device 10 may use screen 12, user interface module 52, and communication channels 38 to detect and process the selection as described above). Responsive to the selection, media command module 56 may retrieve the address book media item associated with the selection, from media item data stores 60. Media command module 56 may transmit the address book media item to user interface module 52. User interface module 52 may send a display command to screen 12 of computing device 10 to display text in edit region 16 associated with the address book entry media item (e.g., the data within each field of the address book entry selected).

The media insertion user interface may include a map user interface. For example, computing device 10 may include a map application that commands screen 12 of computing device 10 to display geographic locations, roads, and places of interest. The map application may include a map user interface for display at screen 12. The map user interface may include a search box displayed at screen 12. Computing device 10 may interpret input received at screen 12 at the location of the search box as associated with a place of interest to the user. The map application may receive the place of interest input and command screen 12 to display a digital map of a geographic area around the place of interest. In another example, computing device 10 may display the map user interface including a digital map. The map application may cause the digital map to pan and zoom based on input received by computing device 10 at screen 12. Computing device 10 may also receive input at screen 12 that the map application may interpret as selections of graphical elements associated with map locations. The map application may store map locations associated with the selections as map location media items in media item data stores 60.

Responsive to detecting gesture 20, computing device 10 may modify user interface 14A to include a media insertion user interface. However, rather than display user interface 14B, the modification to user interface 14A may include displaying, as the media insertion user interface, a subset of the map application user interface. The map application media insertion user interface may include a plurality of map media insertion options. Each map media insertion option may correspond to a map or geographic location media item that computing device 10 may insert into edit region 16. For example, the user may select a graphical element included within the user interface associated with a map location included in the map media insertion user interface (computing device 10 may use screen 12, user interface module 52, and communication channels 38 to detect and process the selection as described above). Responsive to the selection, media command module 56 may retrieve the map location media item associated with the selection, from media item data stores 60. Media command module 56 may transmit the map location media item to user interface module 52. User interface module 52 may modify the user interface to include text in edit region 16 (e.g., text of an address of the map location) and send a display command to screen 12 of computing device 10 to display the modified user interface.

In addition to displaying a map media insertion user interface, computing device 10 may determine a device location and provide the device location to the map application user interface. The map application may calculate a distance or a travel time between a map location displayed on the map user interface and the device location. The media item inserted in edit region 16 may correspond to the distance or the travel time computed by the map application.

For example, input devices 34 of computing device 10 may include a global positioning system (GPS) sensor. The GPS sensor may receive a GPS signal. Based on signal data within the GPS signal, the GPS sensor of computing device 10 may determine a location associated with computing device 10. The GPS sensor may store the device location as a geographic location media item in media item data stores 60.

As described above, computing device 10 may modify user interface 14A to include, as the media insertion user interface, a subset of the map application user interface. The map application media insertion user interface may include a plurality of map media insertion options. One map media insertion option may include an option related to inserting a distance or a travel time between the device location and a map location into edit region 16. For example, the user may select a graphical element that corresponds to a map location included in the map media insertion user interface. Responsive to the map location selection, computing device 10 may determine the distance or travel time between the map location and the device location. The map application may store the distance or the travel time as a map media item in the media item data stores 60. In further response to the selection, media command module 56 may retrieve the map media item from media item data stores 60. Media command module 56 may transmit the map media item to user interface module 52. User interface module 52 may modify the user interface to include text that corresponds to the distance or travel time in edit region 16 and send a display command to screen 12 of computing device 10 to display the modified user interface.

In addition to displaying a map media insertion user interface, computing device 10 may determine a device location and provide the device location to the map application user interface. The map user interface may determine a set of directions for navigating from the device location to a map location on the map user interface. The media item inserted in edit region 16 may correspond to the directions determined by the map user interface.

As described above, input devices 34 of computing device 10 may include a global positioning system (GPS) sensor. The GPS sensor may receive a GPS signal. Based on signal data within the GPS signal, the GPS sensor of computing device 10 may determine a location associated with computing device 10. The GPS sensor may store the device location as a geographic location media item in media item data stores 60.

Also as described above, computing device 10 may modify user interface 14A to include, as the media insertion user interface, a subset of the map application user interface. The map application media insertion user interface may include a plurality of map media insertion options. One map media insertion option may include an option related to inserting directions for navigating between the device location and a map location into edit region 16. For example, the user may select a graphical element that corresponds to a map location included in the map media insertion user interface. Responsive to the map location selection, computing device 10 may determine directions for navigating between the map location and the device location. The map application may store the directions as a map media item in the media item data stores 60. In further response to the selection, media command module 56 may retrieve the map media item from media item data stores 60. As described above, media command module 56 may transmit the map media item to user interface module 52. User interface module 52 may modify the user interface to include text that corresponds to the directions in edit region 16 and send a display command to screen 12 of computing device 10 to display the modified user interface.

The media insertion user interface may include a digital media user interface, and the media item may include a song, an album, an application, a video, an electronic book, or a hyperlink to the media item stored at a repository remote from the computing device. For example, computing device 10 may include a digital media application used for storing, retrieving, viewing, and listening to digital media with computing device 10. The digital media application may include a digital media user interface for display at screen 12. The digital media user interface may include one or more titles to digital media (e.g., songs, albums, electronic books, electronic newspapers, electronic magazines, videos, applications, games, etc.). Computing device 10 may interpret input detected by screen 12 at a location of the digital media user interface as a selection of a graphical element associated with a title. The user may select the title from the digital media user interface to store, retrieve, view, or listen to the digital media item with computing device 10. In addition to titles, the digital media user interface may provide hyperlinks to locations for purchasing or downloading a digital media item on the Internet. The digital media application may store digital media as digital media items in media item data stores 60.

Responsive to detecting gesture 20, computing device 10 may modify user interface 14A to include a media insertion user interface. However, rather than display user interface 14B, the modification to user interface 14A may include displaying, as the media insertion user interface, a subset of the digital media application user interface. The digital media insertion user interface may include a plurality of digital media insertion options. Each digital media insertion option may correspond to a digital media item that computing device 10 may insert into edit region 16 (e.g. a digital song or a hyperlink to the digital song). For example, the user may select a graphical element that corresponds to a title to a song from the digital media insertion user interface (computing device 10 may use screen 12, user interface module 52, and communication channels 38 to detect and process the selection as described above). Responsive to the song selection, media command module 56 may retrieve a digital media item associated with the selection from media item data stores 60. As described above, media command module 56 may transmit the digital media item to user interface module 52. User interface module 52 may modify the user interface to include the digital media item in edit region 16 and send a display command to screen 12 of computing device 10 to display the modified user interface.

The media insertion user interface may include an Internet browser user interface for accessing a webpage. The media item may include a hyperlink associated with a location of the webpage. For example, computing device 10 may include an Internet browser application used for accessing a webpage on the Internet with computing device 10. The Internet browser application may include an Internet browser user interface for display at screen 12. The Internet browser application may cache (store) information related to objects (e.g. images, text, etc.) associated with a webpage downloaded from the Internet, as Internet browser media items in media item data stores 60.

Responsive to detecting gesture 20, the computing device may modify user interface 14A to include a media insertion user interface. However, rather than display user interface 14B, the modification to user interface 14A may include displaying, as the media insertion user interface, a subset of the Internet browser application user interface. The Internet browser media insertion user interface may include a plurality of Internet browser media insertion options. Each Internet browser media insertion option may correspond to an Internet browser media item that computing device 10 may insert into edit region 16 (e.g. a hyperlink to a location for downloading information on the Internet). For example, the user may use the Internet browser application to browse to a webpage on the Internet. The Internet browser application may store information related to objects (e.g. images and text) associated with the webpage as Internet browser media items in media item data stores 60. The user may select a graphical element that corresponds to an object in a webpage included in the Internet browser media insertion user interface (computing device 10 may use screen 12, user interface module 52, and communication channels 38 to detect and process the selection as described above). Responsive to the selection, media command module 56 may retrieve an Internet browser media item associated with the selection from media item data stores 60. As described above, media command module 56 may transmit the Internet browser media item to user interface module 52. User interface module 52 may modify the user interface to include information that corresponds to the Internet browser media item (e.g., the text or image object from the webpage) in edit region 16 and send a display command to screen 12 of computing device 10 to display the modified user interface.

The media insertion user interface may include a voice memo user interface. The media item may include a voice memo audio recording. For example, input devices 34 of computing device 10 may include a microphone for receiving audio from the user (e.g. to record a voice memo, perform speech-to-text functions, or utilize a telephone feature of computing device 10). Computing device 10 may include a voice memo application used for recording audio files with the microphone of computing device 10. The voice memo application may include a voice memo user interface for display at screen 12. The voice memo application may record and play audio files recorded by the user with computing device 10. The voice memo application may store recorded audio files as voice memo media items in media item data stores 60.

Responsive to detecting gesture 20, the computing device may modify user interface 14A to include a media insertion user interface. However, rather than display user interface 14B, the modification to user interface 14A may include displaying, as the media insertion user interface, a subset of the voice memo application user interface. The voice memo media insertion user interface may include a plurality of voice memo media insertion options. Each voice memo media insertion option may correspond to a voice memo media item that computing device 10 may insert into edit region 16 (e.g. an audio file or a hyperlink to a location for downloading the audio file from the Internet). For example, the user may select or otherwise activate a record button displayed on the voice memo media insertion user interface. After detecting that the user activated the record button, computing device 10 may record a voice memo audio file by receiving audio spoken by the user with the microphone of computing device 10. The voice memo application may store the voice memo audio file as a voice memo media item in media item data stores 60. The user may select a graphical element that corresponds to the recorded voice memo audio file. Responsive to the selection, media command module 56 may retrieve the voice memo media item from media item data stores 60. As described above, media command module 56 may transmit the voice memo media item to user interface module 52. User interface module 52 may modify the user interface to include data that corresponds to the voice memo media item (e.g., the audio file or a hyperlink to a location for downloading the audio file from the Internet) in edit region 16 and send a display command to screen 12 of computing device 10 to display the modified user interface.

The media insertion user interface may include an image library user interface. The media item may include an image or a video. For example, input devices 34 of computing device 10 may include a camera for capturing images or video with computing device 10. Computing device 10 may include an image library application used for organizing and viewing images and videos captured with the camera of computing device 10. The image library application may include an image library user interface for display at screen 12. The image library application may store captured images and videos as image library media items in media item data stores 60.

Responsive to detecting gesture 20, the computing device may modify user interface 14A to include a media insertion user interface. However, rather than display user interface 14B, the modification to user interface 14A may include displaying, as the media insertion user interface, a subset of the image library application user interface. The image library media insertion user interface may include a plurality of image library media insertion options. Each image library media insertion option may correspond to an image library media item that computing device 10 may insert into edit region 16 (e.g. an image, a video, or a hyperlink to a location for downloading the image or video from the Internet). For example, computing device 10 may capture an image with the camera of computing device 10. The image library application may store the captured image as an image library media item in media item data stores 60 and may display the captured image in the image library media insertion user interface at screen 12. The user may select a graphical element at screen 12 associated with the captured image included in the image library media insertion user interface. Responsive to the selection, media command module 56 may retrieve the image library media item associated with the captured image from media item data stores 60. As described above, media command module 56 may transmit the image library media item to user interface module 52. User interface module 52 may modify the user interface to include the captured image in edit region 16 and send a display command to screen 12 of computing device 10 to display the modified user interface.

The media insertion user interface may include a received message user interface. The media item may include a received message. The received message may include an e-mail, an instant message, a simple message service message, a voicemail, or a video message. For example, computing device 10 may include a message client application for composing, sending, and receiving electronic communications to other computing devices. The message client application may include a received message user interface for display at screen 12. The message client application may receive a message (e.g., an e-mail) from another computing device and may store the received message as a received message media item in media item data stores 60. The message client application may display a received message in the received message user interface at screen 12. While displaying the received message user interface, the message client application may interpret input received at screen 12. The message client application may interpret the input as commands from the user to select, view, delete, and copy a received message from the received message user interface.

Responsive to detecting gesture 20, the computing device may modify user interface 14A to include a media insertion user interface. However, rather than display user interface 14B, the modification to user interface 14A may include displaying, as the media insertion user interface, a subset of the received message user interface. The received message media insertion user interface may include a plurality of received message media insertion options. Each received message media insertion option may correspond to a received message media item that computing device 10 may insert into edit region 16 (e.g. a received message or a hyperlink to a location for downloading the message from the Internet). For example, computing device 10 may receive an e-mail. The message client application may store the e-mail as a received message media item in media item data stores 60 and may display the received message in the received message media insertion user interface at screen 12. The user may select a graphical element at screen 12 associated with the received message. Responsive to the selection, media command module 56 may retrieve the received message media item associated with the received message from media item data stores 60. As described above, media command module 56 may transmit the received message media item to user interface module 52. User interface module 52 may modify the user interface to include the e-mail that corresponds to the received message media item in edit region 16 and send a display command to screen 12 of computing device 10 to display the modified user interface.

The media insertion user interface may include a calendar user interface. The media item may include a calendar event. For example, computing device 10 may include a calendar application used for storing and retrieving calendar events for display at screen 12 of computing device 10 or for use by other applications executing on computing device 10. The calendar application may include a calendar user interface for display at screen 12. The calendar application may contain one or more calendar events organized, for example, chronologically using a date and a time associated with each event. Each calendar event may include one or more fields. Each field may provide a location for storing information about the event such as a date, a time, a place, and participants associated with each event. The calendar application may store each calendar event as a calendar media item in media item data stores 60.

Responsive to detecting gesture 20, the computing device may modify user interface 14A to include a media insertion user interface. However, rather than display user interface 14B, the modification to user interface 14A may include displaying, as the media insertion user interface, a subset of the calendar application user interface. The calendar media insertion user interface may include a plurality of calendar media insertion options. Each calendar media insertion option may correspond to a calendar media item stored in media item data stores 60 that computing device 10 may insert into edit region 16 (e.g. a calendar event or a field within a calendar event). For example, the user may select a graphical element that corresponds to a calendar event media item from the calendar media insertion user interface. Responsive to the selection, media command module 56 may retrieve the calendar media item from media item data stores 60. As described above, media command module 56 may transmit the calendar media item to user interface module 52. User interface module 52 may modify the user interface to include data that corresponds to the calendar media item (e.g., text within each field of the calendar event selected by the user) in edit region 16 and send a display command to screen 12 of computing device 10 to display the modified user interface.

The media insertion user interface may include an application user interface of an application previously executed by the computing device. The media item may include information associated with the application. For example, computing device 10 may determine a recent application previously executed by computing device 10. The recent application may include a recent application user interface for display at screen 12. The recent application may store information associated with the recent application as a recent application media item in media item data stores 60.

Responsive to detecting gesture 20, the computing device may modify user interface 14A to include a media insertion user interface. However, rather than display user interface 14B, the modification to user interface 14A may include displaying, as the media insertion user interface, a subset of the recent application user interface. The recent application media insertion user interface may include a plurality of recent application media insertion options. Each recent application media insertion option may correspond to a recent application media item that computing device 10 may insert into edit region 16 (e.g. data associated with the recent application). For example, processors 30 of computing device 10 may execute a recent application. The recent application may store data as a recent application media item in media item data stores 60 and may display recent application media insertion options in the recent application media insertion user interface. The user may select a graphical element that corresponds to a recent application media insertion option on the recent application media insertion user interface. Responsive to the selection, media command module 56 may retrieve the recent application media item associated with the selected recent application media insertion option from media item data stores 60. As described above, media command module 56 may transmit the recent application media item to user interface module 52. User interface module 52 may modify the user interface to include data that corresponds to the recent application media item in edit region 16 and send a display command to screen 12 of computing device 10 to display the modified user interface.

The media insertion user interface may include a user interface of an application preselected by a user. The media item may include information associated with the application. Computing device 10 may provide a mechanism for the user to customize the media insertion user interface. For example, an application executing on computing device 10 may include a configuration setting to add the application to the media insertion user interface. Computing device 10 may identify a preselected application based on the configuration setting. The preselected application may include a preselected application user interface for display at screen 12. The preselected application may store data associated with the preselected application as a preselected application media item in media item data stores 60.

Responsive to detecting gesture 20, the computing device may modify user interface 14A to include a media insertion user interface. However, rather than display user interface 14B, the modification to user interface 14A may include displaying, as the media insertion user interface, a subset of the preselected application user interface. The preselected application media insertion user interface may include a plurality of preselected application media insertion options. Each preselected application media insertion option may correspond to a preselected application media item that computing device 10 may insert into edit region 16 (e.g. data associated with the preselected application).

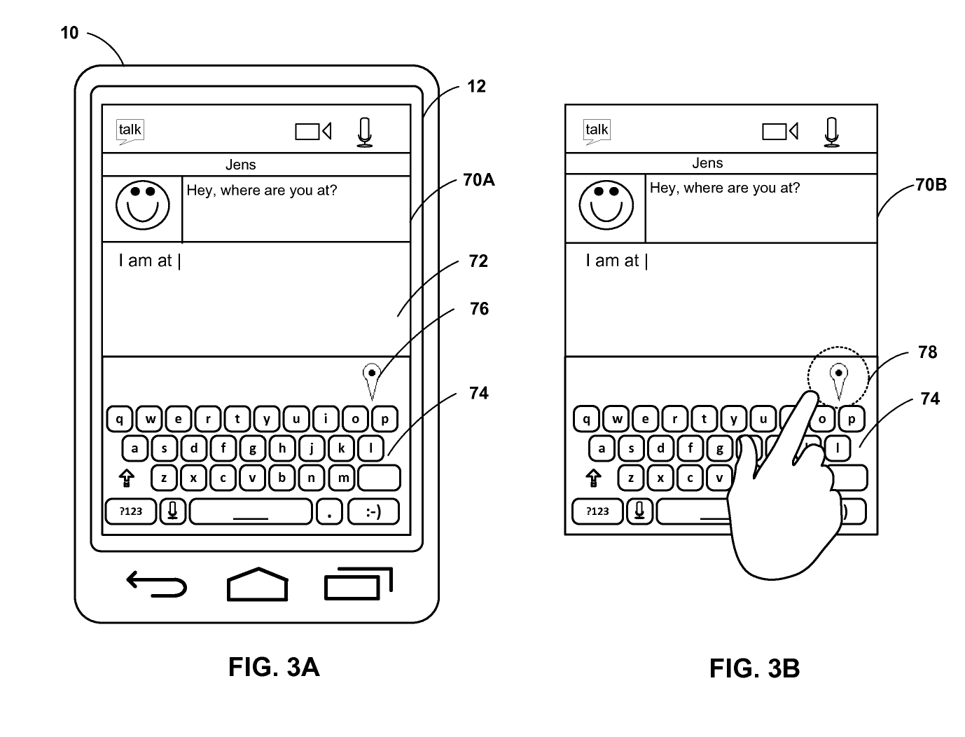

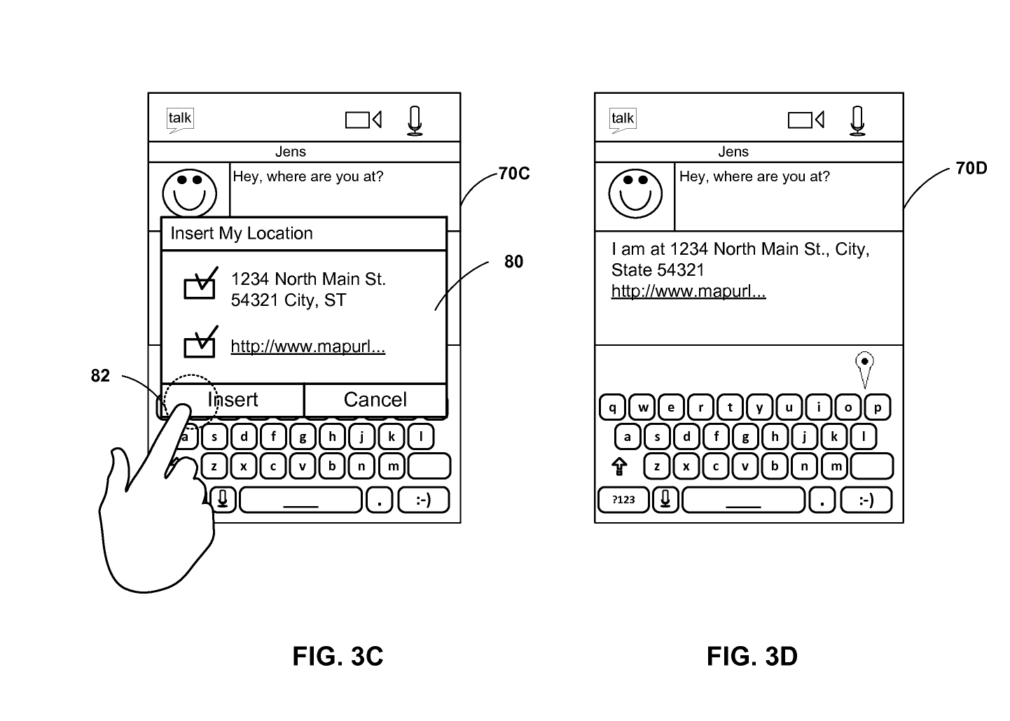

FIGS. 3A-3D are conceptual diagrams illustrating additional example GUIs for inserting media objects, in accordance with one or more aspects of the present disclosure. Computing device 10 of FIG. 3A may output for display at presence-sensitive screen 12 (“screen 12”), GUIs 70A-70D (collectively referred to as user interfaces 70). Computing device 10 of FIG. 3A includes screen 12 for outputting user interfaces 70. Screen 12 may receive user input as one or more taps and gestures (e.g., the user may point to a location on or above screen 12 with a finger or stylus pen). Computing device 10 of FIG. 3A also includes a media insertion module 50 (not shown) that performs similar operations as media insertion module 50 illustrated in FIG. 1A.

Each of user interfaces 70 include graphical elements displayed at various locations of screen 12. In the example of FIG. 3A, user interface 70A includes an edit region 72 and a graphical keyboard 74. Computing device 10 includes a media insertion module 50 for interpreting selections made by the user of graphical elements in user interfaces 70. For example, the user may wish to insert text into edit region 72 of user interface 70A. Computing device 10 may detect user input at a particular location at screen 12. Media insertion module 50 may interpret from the user input, a selection of one or more keys displayed on graphical keyboard 74. Media insertion module 50 may further determine the selection of keys represents a string of characters, with each character from the string, associated with a selected key.

Computing device 10 may output for display at screen 12, user interface 70A, which includes media key 76 within graphical keyboard 74 that provides one or more shortcuts to insert a media item into edit region 72. That is, media key 76 may alleviate the need for the user to physically type on graphical keyboard 74, navigate to another application or to perform cut, copy, or paste functions to insert a media item into an electronic document or message. In the example of FIG. 3A, media key 76 appears as a map location symbol and provides a shortcut for the user to insert a geographic location media item into edit region 72. In the examples of FIGS. 3A-3D, a user would like to insert information associated with a current geographic location of computing device 10 into a text message using media key 76.

As illustrated by FIG. 3B, the user may perform gesture 78 (e.g., a tap gesture) at screen 12 to select media key 76, which causes computing device 10 to display media insertion user interface 80 (illustrated in FIG. 3C). Responsive to receiving an indication of gesture 78 detected at a location of screen 12 within media key 76, computing device 10 may modify user interface 70B to include a media insertion user interface, as shown in FIG. 3C

In the example illustrated in FIG. 3C, user interface 70C includes media insertion interface 80 and may include a plurality of customizable and configurable media insertion options (e.g., options for inserting a media item into edit region 72). For example, FIG. 3C shows two media insertion options included in media insertion user interface 80 (each option is shown as a checkbox graphical element). One media insertion option may correspond to inserting text of an address associated with a location of computing device 10 into edit region 72. The other media insertion option may correspond to inserting a hyperlink to a location on the Internet for downloading a map surrounding the location of computing device 10 into edit region 72. The user may select one or more graphical elements displayed at screen 12 that correspond to each media insertion option. For example, the user may select one or both checkbox graphical elements displayed at screen 12. A selection of each checkbox corresponds to a selection of a single media insertion option.

Computing device 10 may receive an indication of a selection of at least one of the plurality of media insertion options. The at least one selected media insertion option may correspond to a media item. In the example of FIG. 3C, after screen 12 displays media insertion user interface 80, the user performs three tap gestures at three different locations on screen 12. Each tap gesture corresponds to a selection of a different graphic element of user interface 80. The user performs a first tap gesture at a location where screen 12 displays a checkbox graphic element next to an address. The user performs a second tap gesture at a location where screen 12 displays a checkbox graphic element next to a hyperlink. And the user performs a third tap gesture (e.g., selection 82) at a location where screen 12 displays an “insert” button graphic element. In response to screen 12 detecting the third tap gesture, media insertion module 50 may receive an indication of selection 82 from screen 12 and may determine that selection 82 corresponds to a selection of the “insert” button graphic element. Media insertion module 50 may determine that selection 82 also indicates a selection of the two checkbox graphic elements. Media insertion module 50 may determine a selection of the two checkbox graphic elements indicates a selection of two media insertion options that both correspond to inserting a geographic location media item into edit region 72.

Responsive to receiving the indication of selection 82, computing device 10 may output on screen 12 modified user interface 70C including the media item within edit region 72 by, for example, inserting the geographic location media item into edit region 72, as shown in user interface 70D of FIG. 3D. In this example, the geographic location media item includes text that corresponds to an address of a location associated with computing device 10 (e.g., “1234 North Main St., City, State”) and a hyperlink to an Internet website displaying a map of the device location (e.g., “http://www.mapurl . . . ”). Media insertion module 50 may command screen 12 to display user interface 70D which includes the geographic location media item. In this manner, media key 76 (and media insertion user interface 80) may alleviate the need for the user to physically type the address associated with the current location of computing device 10.

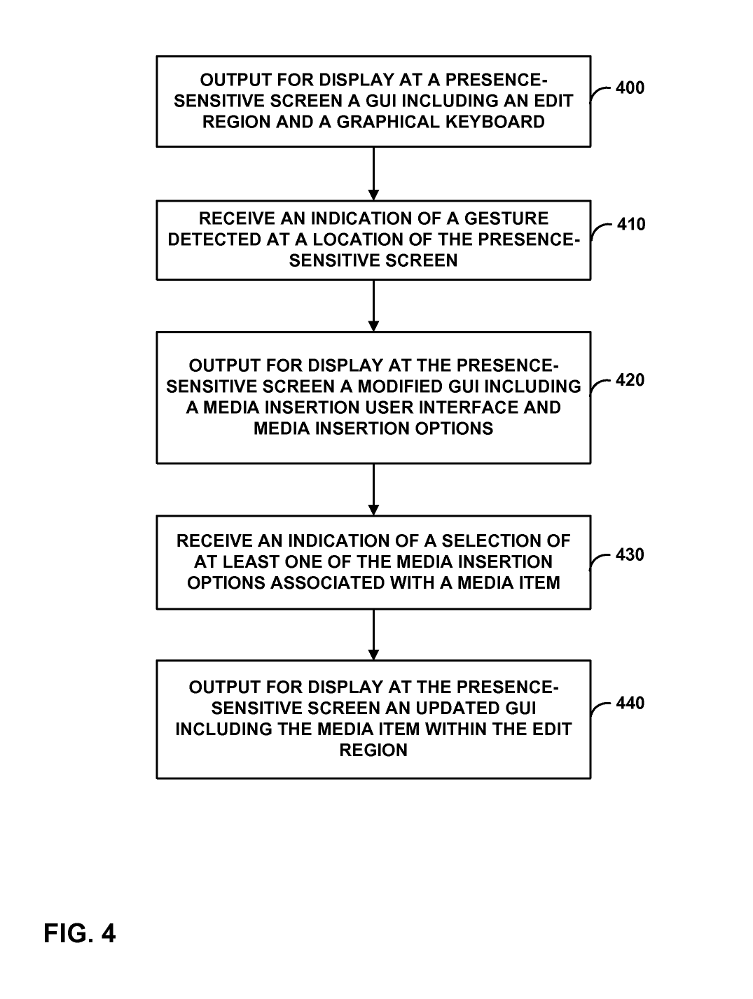

FIG. 4 is a flowchart illustrating an example operation of the computing device, in accordance with one or more aspects of the present disclosure. The process of FIG. 4 may be performed by one or more processors of a computing device, such as computing device 10 illustrated in FIG. 2. For purposes of illustration, FIG. 4 is described below within the context of computing devices 10 of FIGS. 1A-1C, FIG. 2, and FIGS. 3A-3D.

Computing device 10 may output for display at a presence-sensitive screen a GUI including an edit region and a graphical keyboard (400). For example, computing device 10 may output for display at screen 12, user interface 14A that includes edit region 16 and graphical keyboard 18. Computing device 10 may receive an indication of a gesture detected at a location of the presence-sensitive screen (410). For example, computing device 10 may detect gesture 20 at screen 12. Computing device 10 may output for display at the presence-sensitive screen a modified GUI including a media insertion user interface and media insertion options (420). For example, responsive to detecting gesture 20, computing device 10 may modify user interface 14A to include media insertion user interface 22 as illustrated by user interface 14B in FIG. 1B. Computing device 10 may receive an indication of a selection of at least one of the plurality of media insertion options associated with a media item (430). For example, computing device 10 may receive an indication of selection 24 that may correspond to a map media insertion option. The map media insertion option may be associated with a map media item. Computing device 10 may output for display at the presence-sensitive screen an updated GUI including the media item within the edit region (440). For example, responsive to receiving the indication of selection 24, computing device 10 may modify user interface 14B to include the map media item in edit region 16 as illustrated by user interface 14C of FIG. 1C.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
outputting, by a computing device and for display at a presence-sensitive screen, a graphical user interface including:
a graphical keyboard that includes character keys and a swipe region, and
an edit region that, responsive to a selection of one or more of the character keys of the graphical keyboard, includes graphical elements added to the edit region;
receiving, by the computing device, an indication of a swipe gesture detected at a location of the presence-sensitive screen associated with the swipe region of graphical keyboard;
responsive to receiving the indication of the swipe gesture at the location, outputting, by the computing device, for display at the presence-sensitive screen, a modified graphical user interface including a media insertion user interface, the media insertion user interface including a plurality of media insertion options;
receiving, by the computing device, an indication of a selection of at least one of the plurality of media insertion options, the at least one selected media insertion option associated with a media item; and
responsive to receiving the indication of the selection, outputting, by the computing device and for display within the edit region and at the presence-sensitive screen, an updated graphical user interface including a representation of the media item.

2. The method of claim 1,
wherein the graphical keyboard includes a media key, the media key being located within the swipe region of the graphical keyboard, and
wherein the modified graphical user interface that includes the media insertion user interface is output in response to the gesture detected at the location of the presence-sensitive screen which is associated with the media key.

3. The method of claim 1,
wherein outputting the updated graphical user interface further comprises removing the media insertion user interface from the graphical user interface.

4. The method of claim 1, the method further comprising:
outputting, by the computing device, a message that includes the media item.

5. The method of claim 1, wherein the media item is a hyperlink to downloadable information.

6. The method of claim 1, wherein the media insertion user interface comprises an address book user interface, and wherein the media item includes information stored within an entry of an address book.

7. The method of claim 1, wherein the modified graphical user interface includes the media insertion user interface in place of the graphical keyboard.

8. The method of claim 1, wherein the media insertion user interface includes a map user interface, the method further comprising:
determining, by the computing device, a device location, wherein the device location is provided to the map user interface to calculate a distance or a travel time between the map location on the map user interface and the device location, and wherein the media item is the distance or the travel time.

9. The method of claim 1, wherein the media insertion user interface includes a map user interface, the method further comprising:
determining, by the computing device, a device location, wherein the device location is provided to the map user interface to determine a set of directions for navigating from the device location to a map location on the map user interface, and wherein the media item includes the set of directions.

10. The method of claim 1, wherein the media insertion user interface comprises a digital media user interface, and wherein the media item includes a song, an album, an application, a video, an electronic book, or a hyperlink to the media item stored at a repository remote from the computing device.

11. The method of claim 1, wherein the media insertion user interface comprises an Internet browser user interface for accessing a webpage and the media item includes a hyperlink associated with a location of the webpage.

12. The method of claim 1, wherein the media insertion user interface comprises a voice memo user interface, and wherein the media item includes a voice memo audio recording.

13. The method of claim 1, wherein the media insertion user interface comprises an image library user interface, and wherein the media item includes an image or a video.

14. The method of claim 1, wherein the media insertion user interface comprises a received message user interface, and wherein the media item includes a received message.

15. The method of claim 14, wherein the received message comprises an e-mail, an instant message, a simple message service message, a voicemail, or a video message.

16. The method of claim 1, wherein the media insertion user interface comprises a calendar user interface, and wherein the media item includes a calendar event.

17. The method of claim 1, wherein the media insertion user interface comprises an application user interface of an application previously executed by the computing device, and wherein the media item is information associated with the application.

18. The method of claim 1, wherein the media insertion user interface comprises a user interface of an application preselected by a user, and wherein the media item is information associated with the application.

19. A computer-readable storage medium comprising instructions that, when executed, configure one or more processors of a computing device to:
output, for display at a presence-sensitive screen, a graphical user interface including:
a graphical keyboard that includes character keys and a swipe region, and
an edit region that, responsive to a selection of one or more of the character keys of the graphical keyboard, includes graphical elements added to the edit region;
receive an indication of a swipe gesture detected at a location of the presence-sensitive screen associated with the swipe region of the graphical keyboard;
responsive to receiving the indication of the swipe gesture at the location, output for display at the presence-sensitive screen, a modified graphical user interface including a media insertion user interface, the media insertion user interface including a plurality of media insertion options;
receive an indication of a selection of at least one of the plurality of media insertion options, the at least one selected media insertion option being associated with a media item; and
responsive to receiving the indication of the selection, output, for display within the edit region and at the presence-sensitive screen, an updated graphical user interface including a representation of the media item.

20. A computing device comprising one or more processors, the one or more processors being configured to:
output, for display at a presence-sensitive screen, a graphical user interface including:
a graphical keyboard that includes character keys and a swipe region, and
an edit region that, responsive to a selection of one or more of the character keys of the graphical keyboard, includes graphical elements added to the edit region;
receive, an indication of a swipe gesture detected at a location of the presence-sensitive screen associated with the swipe region of the graphical keyboard;
responsive to receiving the indication of the swipe gesture at the location, output, for display at the presence-sensitive screen, a modified graphical user interface including a media insertion user interface in place of the graphical keyboard, the media insertion user interface including a plurality of media insertion options; and
receive an indication of a selection of at least one of the plurality of media insertion options, the at least one selected media insertion option being associated with a media item;
responsive to receiving the indication of the selection, output for display within the edit region and at the presence-sensitive screen, an updated graphical user interface including a representation of the media item.
